(19) United States
(12) Patent Application Publication
(10) Pub. No.: US 2010/0102673 A1
(43) Pub. Date: Apr. 29, 2010

(54) Kinetic harvesting frequency optimizer

(75) Inventor: Marko J. Leukkunen, Oulu (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/288,926

(22) Filed: Oct. 24, 2008

(51) Int. Cl. H02N 2/18; H02J 7/00

(52) U.S. Cl. 310/318; 320/137

(57) ABSTRACT

Disclosed herein is an apparatus. The apparatus includes a kinetic energy scavenger mechanism and a frequency tuning system. The kinetic energy scavenger mechanism is configured to harvest energy from a movement of a portable device. The kinetic energy scavenger mechanism includes at least one piezo member. The frequency tuning system is connected to the kinetic energy scavenger system. The frequency tuning system is configured to tune a harvesting frequency of the at least one piezo member based on, at least partially, a characterization of the movement of the portable device.

### BACKGROUND OF THE INVENTION

1. Field of the Invention

The invention relates to an electronic device and, more particularly, to a kinetic harvesting frequency optimizer for an electronic device.

2. Brief Description of Prior Developments

Kinetic energy harvesters (or scavengers) are based on movement of the harvester, and the kinetic energy that is provided in the movement of an actuator. Movement is turned into electricity by the movement of a cantilever and/or a mass. The electricity that is produced by the kinetic energy harvester can then be used to charge batteries and used directly into the appliance during operation.

### SUMMARY

In accordance with one aspect of the invention, an apparatus is disclosed. The apparatus includes a kinetic energy scavenger mechanism and a frequency tuning system. The kinetic energy scavenger mechanism is configured to harvest energy from a movement of a portable device. The kinetic energy scavenger mechanism includes at least one piezo member. The frequency tuning system is connected to the kinetic energy scavenger system. The frequency tuning system is configured to tune a harvesting frequency of the at least one piezo member based on, at least partially, a characterization of the movement of the portable device.

In accordance with another aspect of the invention, an apparatus is disclosed. The apparatus includes a housing, electronic circuitry, and an energy harvesting system. The electronic circuitry is in the housing. The energy harvesting system is proximate the housing. The energy harvesting system includes a kinetic member and a frequency tuning system. The frequency tuning system is configured to change a stiffness of the kinetic member based on, at least partially, a predicted movement pattern of the housing.

In accordance with another aspect of the invention, a method is disclosed. A housing is provided. Electronic circuitry is installed in the housing. An energy harvesting system is provided proximate the housing. The energy harvesting system includes at least one piezo member and a frequency tuning system. The frequency tuning system is configured to tune a harvesting frequency of the at least one piezo member based on an operation mode of a portable device.

In accordance with another aspect of the invention, a method is disclosed. Movements of a portable device are detected. The detected movements are analyzed. An environment of the portable device is determined based on, at least partially, the analyzed detected movements.

In accordance with another aspect of the invention, a method is disclosed. Movements of a portable device are sensed. The sensed movements are characterized. A stiffness of a kinetic energy harvesting member is changed based on, at least partially, the characterization of the sensed movements.

In accordance with another aspect of the invention, a program storage device readable by a machine, tangibly embodying a program of instructions executable by the machine for performing operations to tune a frequency of an energy harvesting system is disclosed. A movement pattern of a portable device is detected. A frequency corresponding to the detected movement pattern is determined. A voltage is applied to a piezo member based on, at least partially, the determined frequency.

### BRIEF DESCRIPTION OF THE DRAWINGS

The foregoing aspects and other features of the invention are explained in the following description, taken in connection with the accompanying drawings, wherein:

FIG. 1 is a perspective view of an electronic device incorporating features of the invention;

FIG. 2 is a schematic drawing illustrating components of an energy harvesting system used in the device shown in FIG. 1;

FIG. 3 is a graphical illustration of frequency measurements;

FIG. 4 is a graphical illustration of frequency measurements for a bus ride example;

FIG. 5 is a graphical illustration of frequency measurements for a walking example;

FIG. 6 is a graphical illustration of frequency measurements for a metro ride;

FIG. 7 is a graphical illustration of frequency measurements for a car ride/drive example;

FIG. 8 is a graphical illustration of frequency measurements for a trip example;

FIG. 9 is a graphical illustration of frequency measurements for a kinetic member having a first stiffness;

FIG. 10 is a is a graphical illustration of frequency measurements for a kinetic member having a second stiffness;

FIG. 11 is a schematic drawing illustrating components of another energy harvesting system used in the device shown in FIG. 1;

FIG. 12 is block diagram of an exemplary method of the device shown in FIG. 1;

FIG. 13 is block diagram of another exemplary method of the device shown in FIG. 1;

FIG. 14 is block diagram of another exemplary method of the device shown in FIG. 1;

FIG. 15 is a schematic drawing illustrating components of the electronic device shown in FIG. 1; and

FIG. 16 is a schematic drawing illustrating components of exemplary electronic devices incorporating features of the invention.

### DETAILED DESCRIPTION

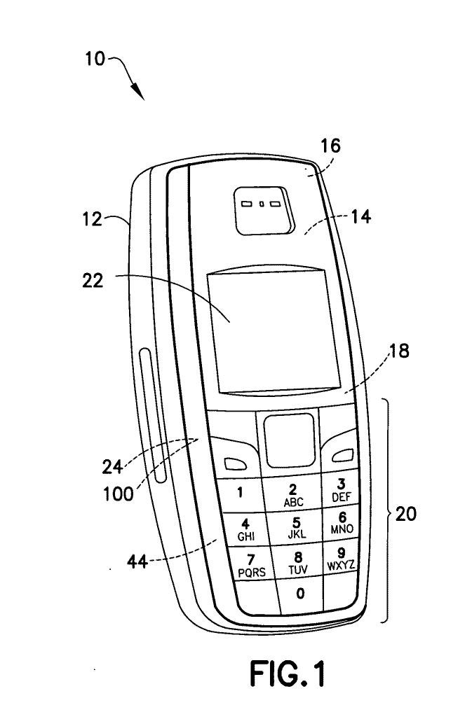

Referring to FIG. 1, there is shown a perspective view of a portable electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention shown in FIG. 1, the device 10 is a multi-function portable electronic device. However, in alternate embodiments, features of the various embodiments of the invention could be used in any suitable type of portable electronic device such as a mobile phone, a gaming device, a music player, a notebook computer, or a PDA, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. It should be noted that in alternate embodiments, the device 10 can have any suitable type of features as known in the art.

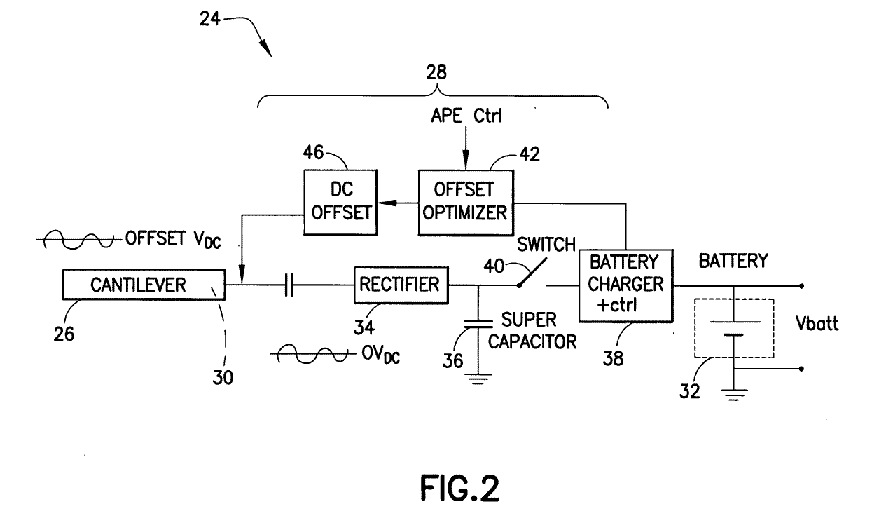

The electronic device 10 further comprises an energy harvesting system 24 (see also FIG. 2). The energy harvesting system 24 comprises a kinetic energy scavenger mechanism 26 and a frequency tuning system 28. The kinetic energy scavenger mechanism 26 comprises a kinetic member 30, which may be a kinetic piezo element for example. The kinetic piezo element 30 may extend from a portion of the kinetic energy scavenger mechanism 26 in a general cantilever fashion. However, any suitable mounting configuration between the kinetic piezo element 30 and the kinetic energy scavenger mechanism 26 may be provided. The piezo cantilever element 30 is connected to a battery 32. As illustrated in FIG. 2, a rectifier 34, a capacitor (which may be a super capacitor for example) 36, a battery charger 38, and a switch 40 may be connected between the piezo cantilever element 30 and the battery 32. However, any suitable energy harvesting system configuration may be provided.

The frequency tuning system 28 comprises an offset optimizer 42 configured to receive input from sensors 44 or other device applications (such as application engine control (APE Ctrl) for example). The sensors 44 may be acceleration sensors or vibration sensors for example. However, any suitable type of sensor or sensors may be provided. The offset optimizer 42 is connected between the battery charger 38 and the piezo cantilever element 30. This configuration allows for the offset optimizer 42 to apply a DC (offset) voltage 46 to the piezo cantilever element 30. Additionally, it should be noted that in alternate embodiments the offset optimizer may receive inputs from other (separate) devices.

The frequency tuning system 28 allows for adaptively optimizing the energy harvester performance. The energy harvesting system (or kinetic charger) 24 may be used in mobile phones and/or accessories (such as Bluetooth® headsets, for example) to prolong battery operation time. However, the energy harvesting system 24 may be provided in any suitable electronic device. In one alternate embodiment, the energy harvesting system may be disposed within an accessory device, such as a Bluetooth® headset for example, and the sensor(s)/device applications may be a part of a separate device, such as a mobile phone for example. This would allow for the sensors/applications of the mobile phone to sense and/or predict a movement pattern of the user (and thus a movement pattern of the mobile phone and the headset) to provide an input for controlling the frequency tuning system in the accessory.

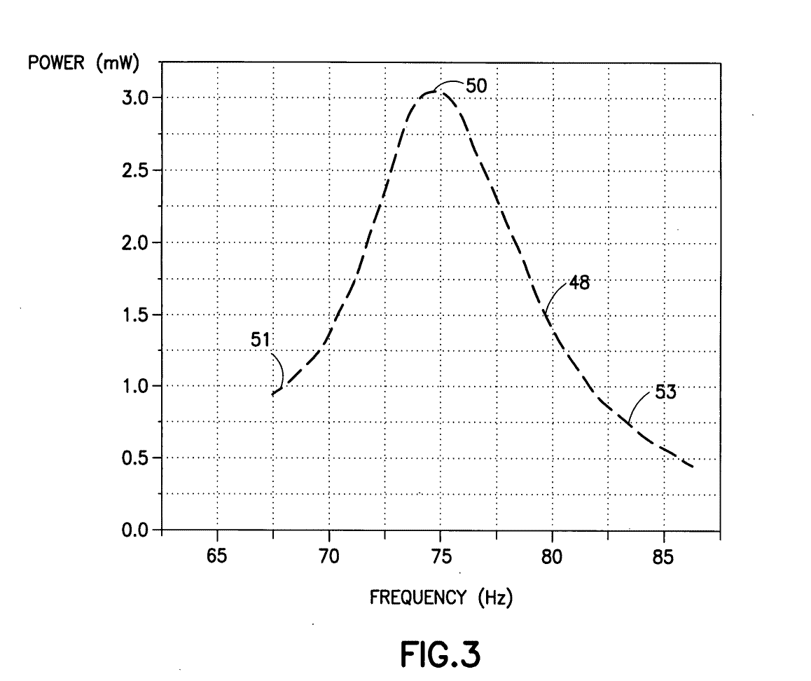

FIG. 3 illustrates an energy harvesting curve 48, showing the amount of power that the cantilever 30 can produce versus (vs.) frequency that is measured. A distinct peak 50 can be seen for the optimized frequency of the piezo cantilever element 30 harvested energy measurement. It can be seen from FIG. 3 that the amount of energy harvesting is highly dependent on the frequency, and only about a 10% change on the frequency can drop the amount of energy harvesting to about ⅓ from the maximum available. For example, at about 75 Hz, the energy harvested is about 3 mW, whereas at about 67.5 Hz (or 82.5 Hz), the energy harvested is only about 1 mW (see 51, 53 in FIG. 3).

Embodiments of the invention provide intelligent frequency tuning to maximize energy harvesting in the kinetic energy scavenger. By tuning the frequency of the piezo cantilever member 30, optimal (battery) charging performance can be achieved (as shown in FIG. 3).

Tuning of the piezo cantilever member 30 to an optimal (harvesting) frequency may be achieved by applying a DC voltage 46 back into the piezo cantilever member 30. Data from the sensors 44 in the device 10 may be used to optimize the energy harvesting frequency of the kinetic cantilevers 30. The data received by the offset optimizer 42 may be used to characterize movements of the device 10. This in turn allows the offset optimizer 42 to determine an amount or value of the DC offset 46 to be applied to the cantilever 30. Applying the DC offset 46 to the cantilever member 30 changes the stiffness of the cantilever member 30 and, thus, the frequency that is optimal for vibration.

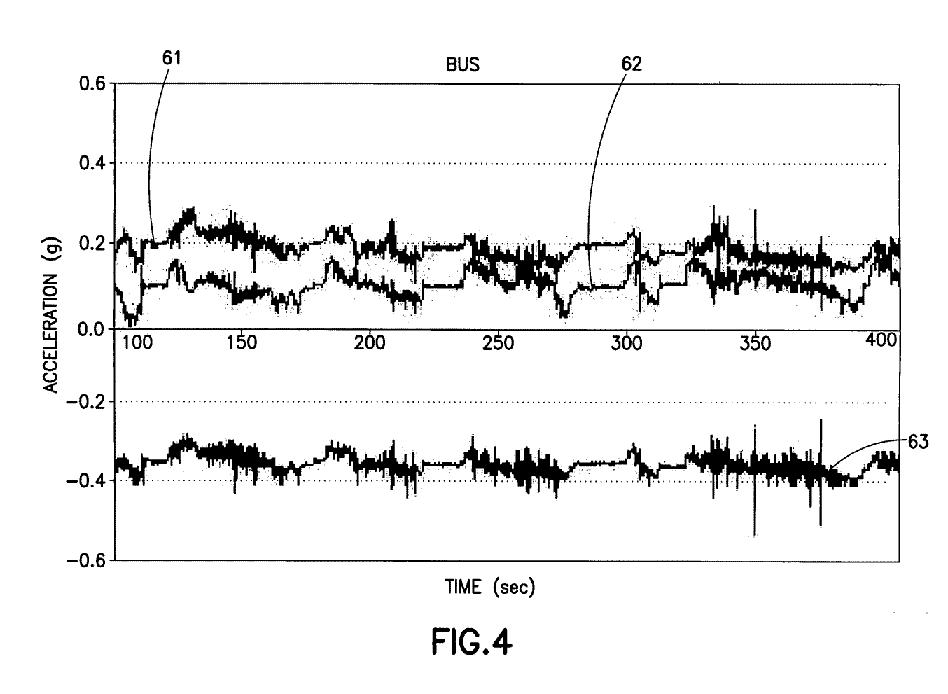

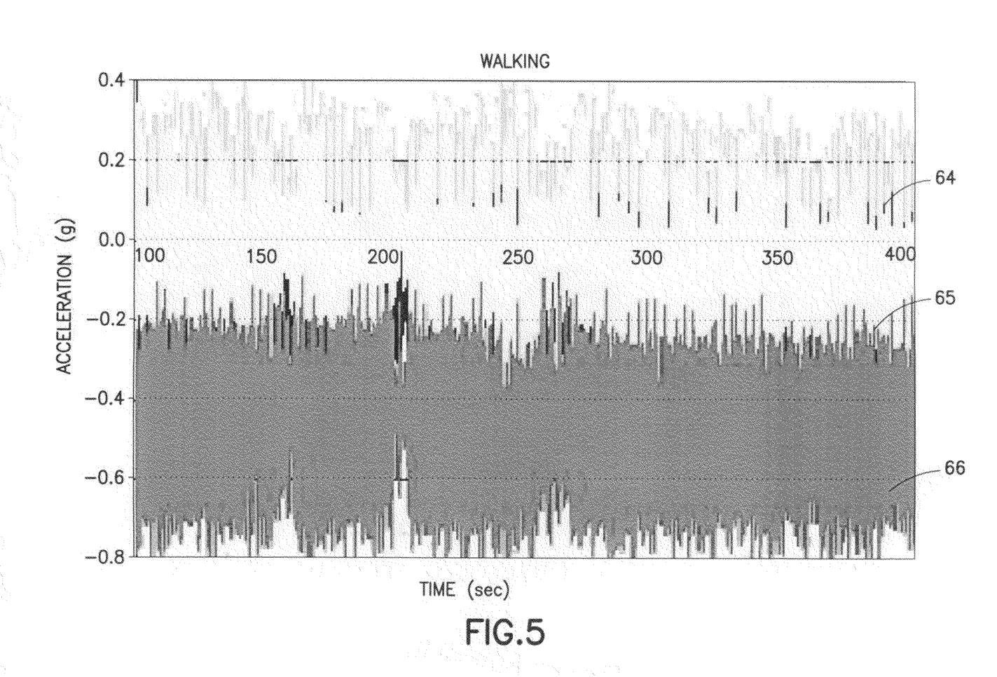

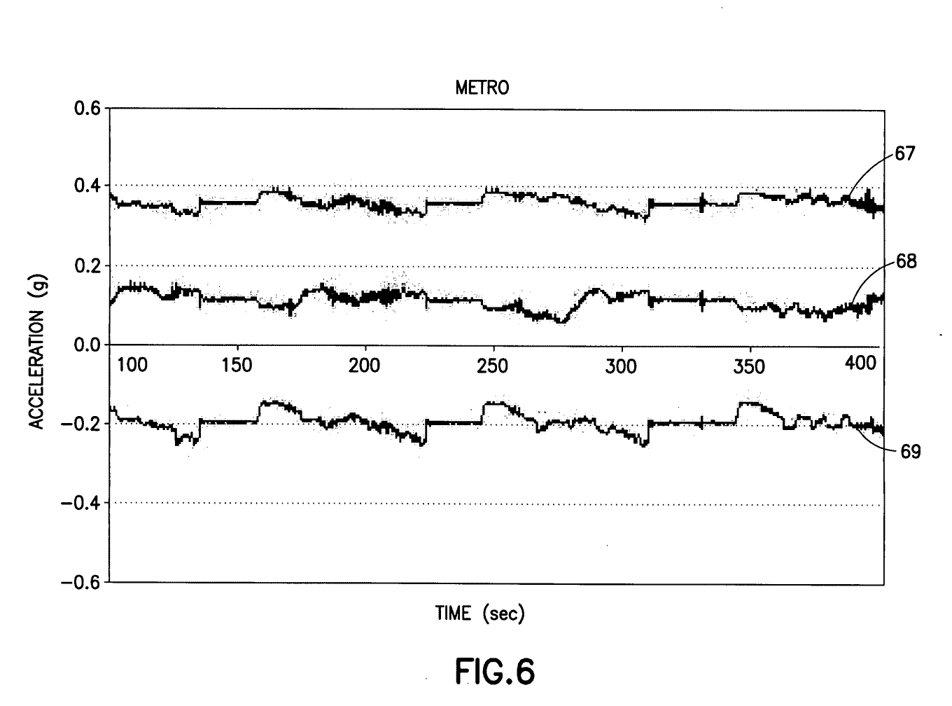

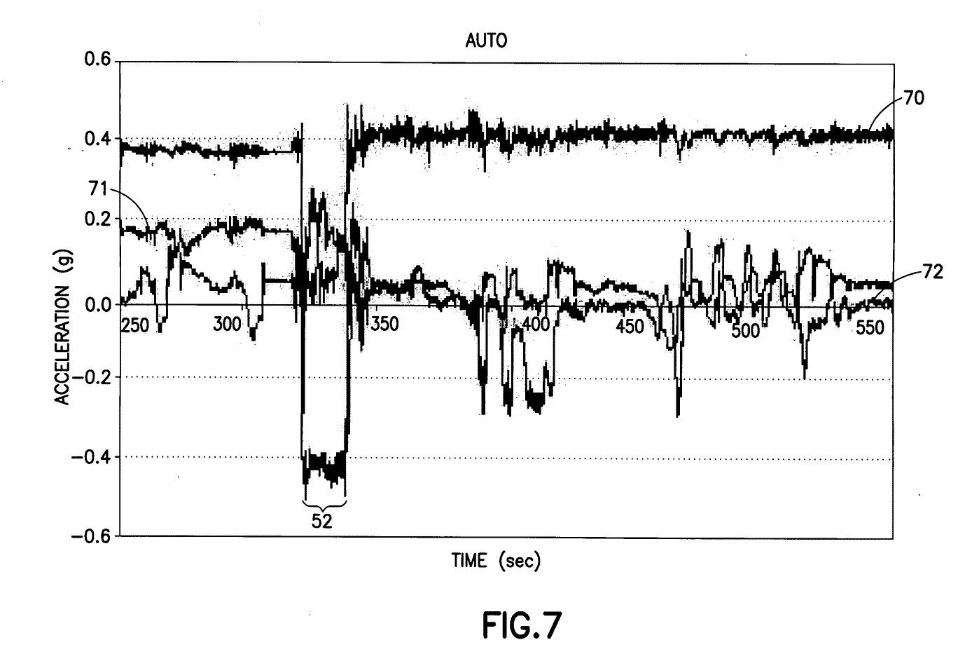

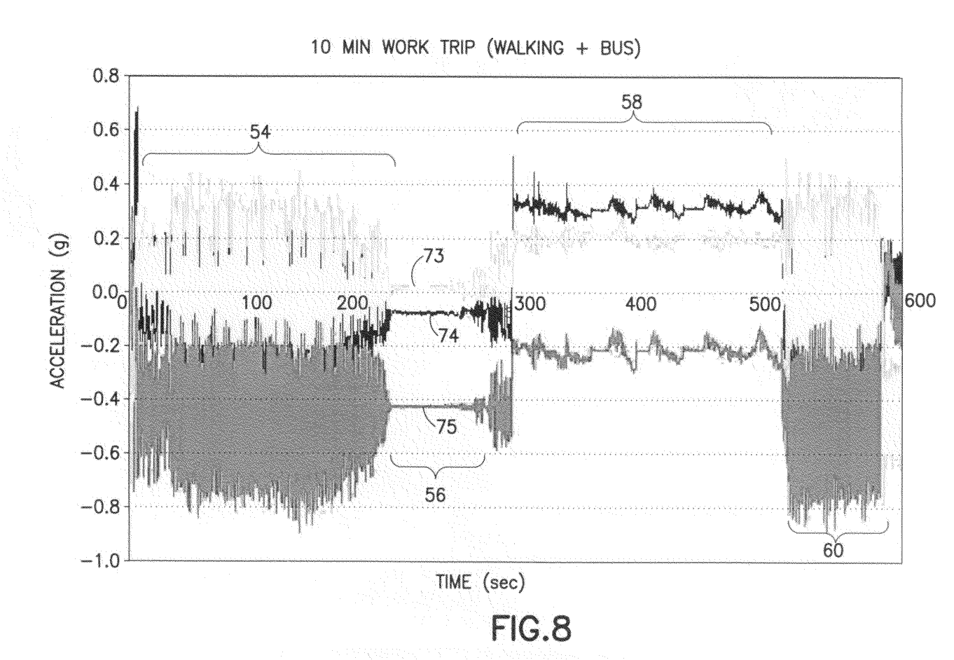

Different movements (or movement patterns) of the device (or the housing) provide different accelerations/vibrations. As illustrated in FIGS. 4-8, the vibrations or vibration pattern may depend on the activity (such as running, walking, skiing, riding a bus or car, sitting in a meeting, etc.) a user of the device is engaged in. For example, FIG. 4 illustrates raw acceleration data series 61, 62, 63 [acceleration (g) vs. time (sec)] for a user of the device while riding on a bus. FIG. 5 illustrates raw acceleration data series 64, 65, 66 for a user of the device while walking. FIG. 6 illustrates raw acceleration data series 67, 68, 69 for a user of the device while riding on a metro. FIG. 7 illustrates raw acceleration data series 70, 71, 72 for a user of the device while riding in an automobile. Please note, portion 52 may be a response while the user has the device in his/her hand, while the rest of the graph/plot illustrates the device in the pocket of the user. FIG. 8 illustrates raw acceleration data series 73, 74, 75 for a user of the device while walking 54, waiting at a bus stop 56, riding on the bus 58, and walking (after exiting the bus, for example) 60. It should be noted that the three data series (for example the data series 61, 62, 63 in the “riding the bus example” of FIG. 4) illustrated in FIGS. 4-8 may represent three axis of a single acceleration sensor, for example. In alternate embodiments, the three data series may represent data from different sensors. However, any suitable sensor configuration may be provided. It should further be noted that the accelerations shown in the figures are for illustration purposes. In alternate embodiments, any suitable acceleration or vibration data/measurements may be provided and/or utilized.

Embodiments of the invention provide for a frequency tuning system 28 which receives data or inputs from the sensors 44 in order to allow the system to have predictive and/or adaptive capabilities (based on the detected movement (s)), so that the maximum kinetic power is harvested. It should be noted that the sensor data from the sensors 44 in the device may be sensors associated with other applications. However, application specific sensors (specific to the energy harvesting system 24) may be provided. In addition, any suitable combination of sensors may be provided.

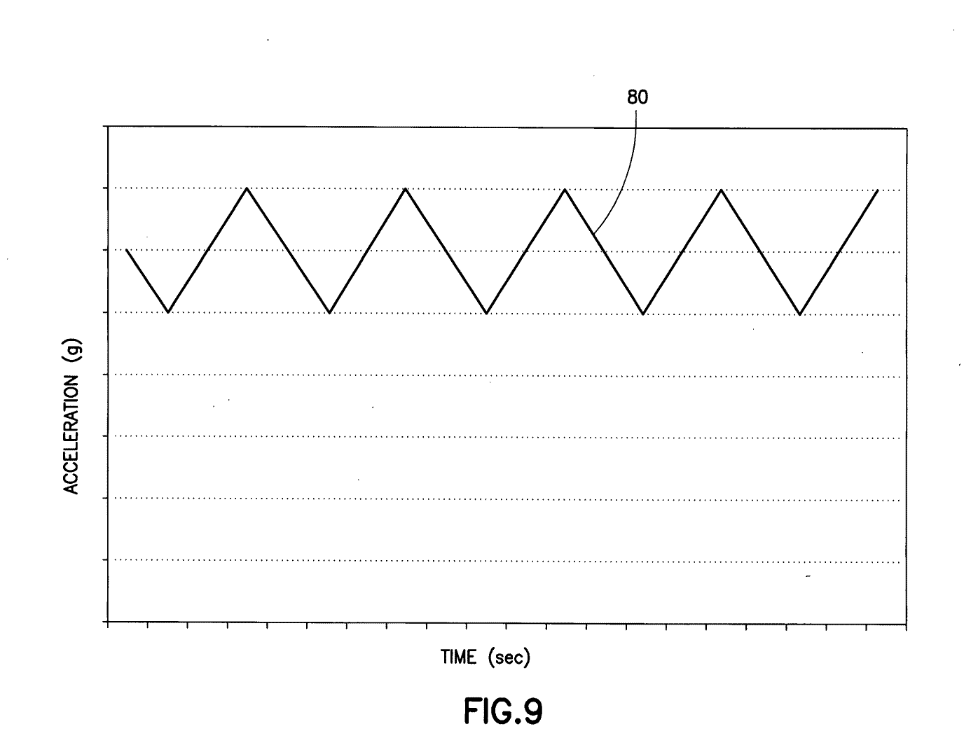

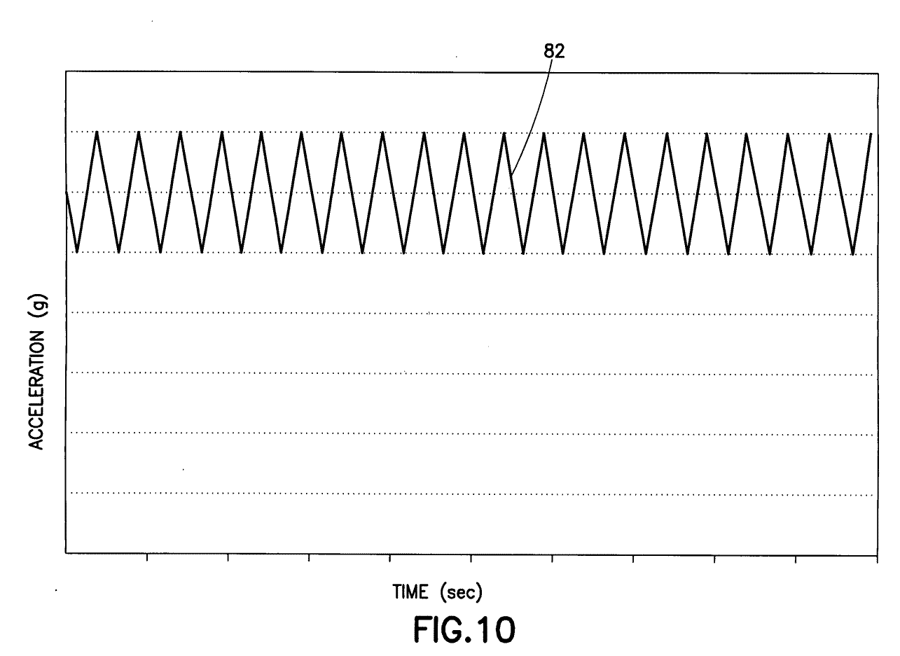

FIGS. 9 and 10 represent an illustrative example of the frequency tuning system 28 changing a resonant frequency of the kinetic member 30 to a different frequency that is optimized for the particular vibration experienced. For example, FIG. 9 illustrates acceleration data 80 [acceleration (g) versus time (sec)] for the kinetic member 30 having a first stiffness value (and a first corresponding frequency). The first corresponding frequency value may be about 67.5 Hz. If a user of the device engaged in an activity (such as running, walking, etc.) which resulted in a device vibration measuring about 75 Hz, the power harvested by the energy harvesting system 24 would not be optimal as the frequency of the activity and the resonant frequency of the kinetic member 30 would differ (see point 51 in FIG. 3). Embodiments of the invention provide for a stiffness of the kinetic member 30 to be changed. For example, if the stiffness of the kinetic member 30 is changed to a second stiffness value (and a second corresponding frequency), as shown in FIG. 10 illustrating acceleration data 82 [acceleration (g) versus time (sec)] for the kinetic member 30 with the changed stiffness/frequency, an optimized energy harvesting configuration can be provided as the frequency of the activity and the resonant frequency of the kinetic member 30 are about the same (see point 50 in FIG. 3). In this example, the second corresponding frequency value may be about 75 Hz. It should be noted that the frequency ranges listed above are merely examples provided for illustration purposes and that any suitable frequency ranges may be provided.

According to one example of the invention, a method to control the optimal cantilever harvesting frequency with applied DC voltage is disclosed. The device may comprise software to control the operation of the energy harvesting system 24 as described above, by means of the information at hand from the sensors 44 that may predict what kind of movement there is to be forthcoming.

According to one embodiment of the invention, the offset optimizer 42 may be configured to receive input from device applications instead of, or in addition to, the sensors 44. Software applications may control and have more intensive characterization period and normal operation mode (as running intensive computation software and sensors also use power). For example, the operation of the frequency tuning system 28 could be automatically provided when the user starts or opens a certain software application, such as a Nokia® Sportstracker application, for example. In this example, the offset optimizer 42 of the frequency tuning system 28 could determine that a running exercise is being performed by the user (as the Nokia® Sportstracker application is opened), and thus the offset optimizer 42 would determine what kind of movement and accelerations the device 10 will experience (while running/exercising) and would provide a corresponding DC offset 46 to tune the piezo cantilever member 30 into a frequency for optimal operation.

Another example could be when the user starts or opens a Nokia® Maps application (or GPS application for example). In this example, the offset optimizer 42 of the frequency tuning system 28 could determine that the user is riding/driving in a car, and thus the offset optimizer 42 would determine what kind of movement and accelerations the device 10 will experience (while riding in a car) and would provide a corresponding DC offset 46 to tune the piezo cantilever member 30 into a frequency for optimal operation.

In addition, the offset optimizer 42 may also sense that the user has changed the operation mode of the device 10 from Nokia® Sportstracker to Nokia® Maps and correspondingly tune the cantilever 30 from a “running” harvesting profile to a “car/auto” harvesting profile. This provides for the frequency tuning system 28 to detect movements of the device 10 by the starting or opening of a software application. Further, there may be applications that automatically start or open (or log on) based on the sensor data/information.

According to another embodiment of the invention, the inputs received by the frequency tuning system 28 may be analyzed to determine an environment of the device 10 (and the housing 12). This may, for example, use the sensor data to automatically determine if a user is walking or riding in a car for example. The device may then use this information to automatically tune the piezo cantilever 30 and/or open a specific software application. However, in alternate embodiments, any suitable device functionality may be provided with the determined environment capability.

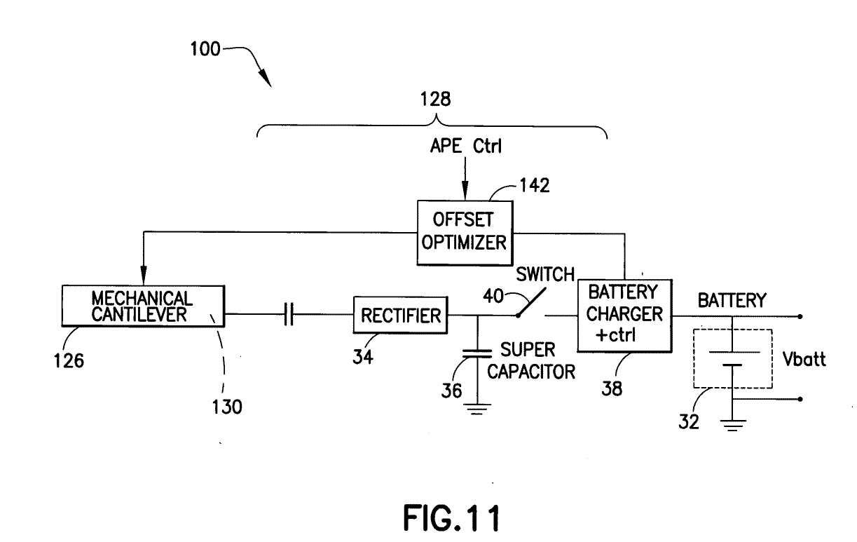

Referring now also to FIG. 11, there is shown an energy harvesting system 100 in accordance with another embodiment of the invention. Similar to the energy harvesting system 24, the energy harvesting system 100 comprises a kinetic energy scavenger mechanism 126 and a frequency tuning system 128. However, in this embodiment, the kinetic energy scavenger mechanism (or mechanical cantilever) 126 comprises a piezo cantilever element 130 that may be mechanically adjusted. Additionally, the offset optimizer 142 provides a signal to the mechanical cantilever 126 to adjust a length of the piezo cantilever element 130, instead of applying a DC voltage 46 to the piezo cantilever element 30. The mechanical cantilever 126 may comprise any suitable electromechanical device which provides a mechanical motion in response to an electrical signal. For example, a mounting configuration and/or position may be moved/adjusted to change the stiffness of the piezo member 130. Similar to the DC offset 46 in the energy harvesting system 24, changing a length of the piezo cantilever member 130 changes the stiffness of the cantilever member 130 and thus the frequency that is optimal for vibration.

According to various embodiments of the invention, the optimized frequency tuning capability may be provided in other suitable fashions. For example, a simpler approach for optimizing the frequency may comprise analogue methods and/or may include a set of characterized harvesting profiles that could be tuned, and controlled by software applications. According to one embodiment, a device could have a set of characterized harvesting profiles that could be tuned, controlled by analog stimulus that is cycling through those profiles and determines what is the best one for certain period, and repeating this measurement at some point (or control from smarter device to use a certain harvesting profile). These methods may be provided as some devices may not have sensors to measure movement, or do not have the ability to characterize movement on the fly or as a one time tuning period. These devices therefore may not have “predictive” operation, thus needing this information from another device if possible. Or mentioned above, the device may be operated in closer to analogue mode by simply maximizing energy harvesting by tuning the frequency.

Kinetic piezo elements are tuned for a certain frequency so that they work optimally. This frequency is highly depending on the behavior of the user and the frequencies that the user is producing while moving. Conventional configurations only use general behavior models of the phone or accessory to model this. Conventional configurations having a kinetic cantilever energy harvester generally comprise “factory” tuned elements/components tuned into a certain frequency. A tuned frequency (or multiple) of conventional harvester configurations may be provided as a best guess to the predicted movement that device will “see”. Kinetic energy scavenger manufacturers attempt to use information from device movement testing to get enough information to characterize the frequencies that the device sees/experiences. These frequencies may not apply to the user habits and are a best guess of the device movement, thus not giving the optimal operation. It is more optimal to provide the frequency tuning as adaptive and use all data available in the accessory or in the phone to harvest energy in a best possible way.

The technical effects of any one or more of the exemplary embodiments of the invention provide for significantly enhanced operation of the kinetic energy scavenger 24, 100 by adaptive frequency tuning, when compared to conventional configurations. Additionally the technical effects enable predictive operation in frequency tuning from other sensors (for example, sensors not directly associated with the energy harvesting system) or user software applications. This allows for using of the sensors available to characterize movement of the device.

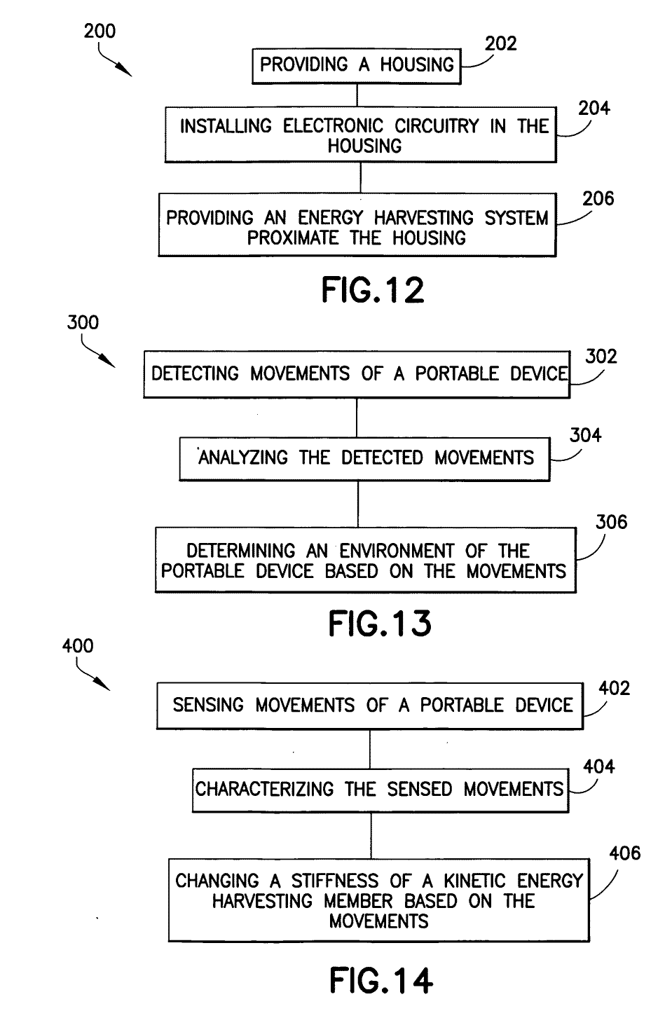

FIG. 12 illustrates a method 200. The method 200 includes the following steps. Providing a housing (step 202). Installing electronic circuitry in the housing (step 204). Providing an energy harvesting system proximate the housing, wherein the energy harvesting system comprises at least one piezo member and a frequency tuning system, and wherein the frequency tuning system is configured to tune a harvesting frequency of the at least one piezo member based on an operation mode of a portable device (step 206). It should be noted that any of the above steps may be performed alone or in combination with one or more of the steps.

FIG. 13 illustrates a method 300. The method 300 includes the following steps. Detecting movements of a portable device (step 302). Analyzing the detected movements (step 304). Determining an environment of the portable device based on, at least partially, the analyzed detected movements (step 306). It should be noted that any of the above steps may be performed alone or in combination with one or more of the steps.

FIG. 14 illustrates a method 400. The method 400 includes the following steps. Sensing movements of a portable device (step 402). Characterizing the sensed movements (step 404). Changing a stiffness of a kinetic energy harvesting member based on, at least partially, the characterization of the sensed movements (step 406). It should be noted that any of the above steps may be performed alone or in combination with one or more of the steps.

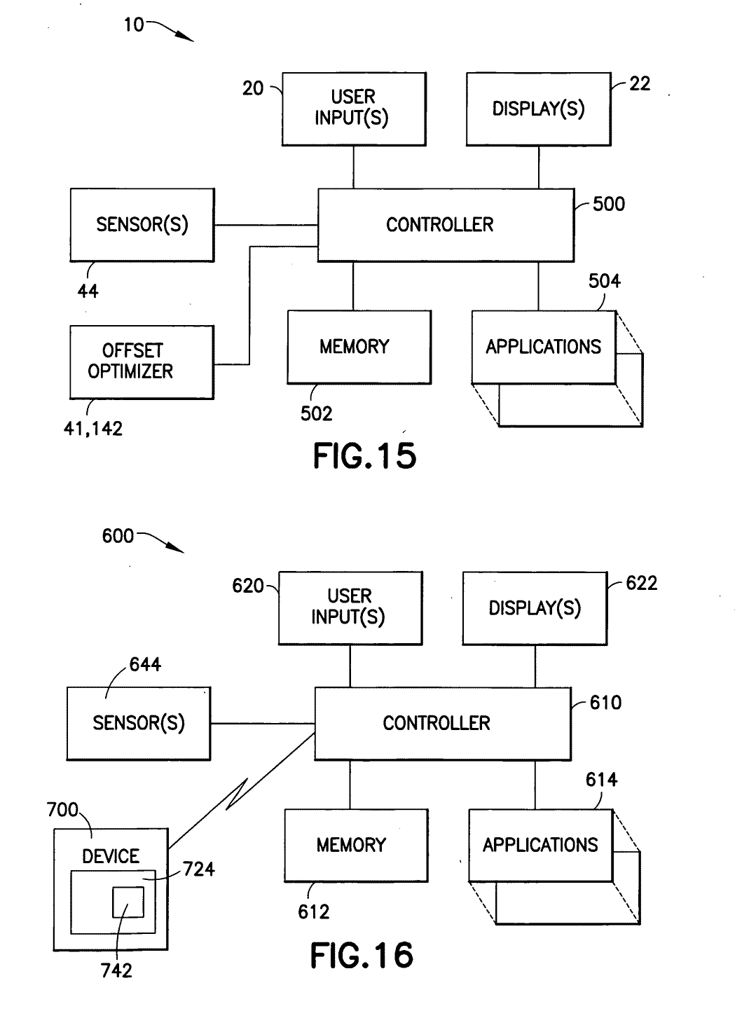

Referring now also to FIG. 15, the device 10 generally comprises a controller 500 such as a microprocessor for example. The electronic circuitry includes a memory 502 coupled to the controller 500, such as on a printed circuit board for example. The memory could include multiple memories including removable memory modules for example. The device has applications 504, such as software, which the user can use. The applications can include, for example, a telephone application, an Internet browsing application, a game playing application, a digital camera application, a sportstracker application, a map/gps application, etc. These are only some examples and should not be considered as limiting. One or more user inputs 20 are coupled to the controller 500 and one or more displays 22 are coupled to the controller 500. The sensors 44 and the offset optimizer 42, 142 are also coupled to the controller 500. However, it should be noted that the sensors 44 are not required and that other configurations may be provided. The device 10 may programmed to automatically change an optimal harvesting frequency. However, in an alternate embodiment, this might not be automatic. The user might need to actively select a change of the optimal harvesting frequency.

Referring now also to FIG. 16, a device 600 in accordance with another embodiment is illustrated. Similar to the device 10, the device 600 generally comprises a controller 610 such as a microprocessor for example, a memory 612, applications 614, user input(s) 620, display(s) 622, and sensor(s) 644. One difference between the device 600 and the device 10 is that the device 600 is configured to control an energy harvesting 724 system of another separate device 700. In one embodiment, the device 600 may be a mobile phone and the device 700 may be a headset, or vice versa. However, any suitable devices may be provided. As shown in FIG. 16, the device 600 is linked to another separate device 700. The linked connection 800 may be a direct connection or a wireless connection (such as a Bluetooth® connection for example). However, any suitable connection may be provided. The memory 612 (connected to electronic circuitry) is coupled to the controller 610, such as on a printed circuit board for example. The memory could include multiple memories including removable memory modules for example. The device 600 has applications 614, such as software, which the user can use. The applications can include, for example, a telephone application, an Internet browsing application, a game playing application, a digital camera application, a sportstracker application, a map/gps application, etc. These are only some examples and should not be considered as limiting. One or more user inputs 620 are coupled to the controller 610 and one or more displays 622 are coupled to the controller 610. The sensors 644 are also coupled to the controller 610. However, it should be noted that the sensors 644 are not required and that other configurations may be provided. In this embodiment, the controller 610 sends an input to an offset optimizer 742 of the device 700 to control the energy harvesting system 724. The input sent to the offset optimizer may correspond to sensor 644 and/or application 614 information from the device 600. The device 600 may programmed to automatically change an optimal harvesting frequency of the device 700. However, in an alternate embodiment, this might not be automatic. The user might need to actively select a change of the optimal harvesting frequency.

According to one example of the invention, an apparatus is disclosed. The apparatus includes a kinetic energy scavenger mechanism and a frequency tuning system. The kinetic energy scavenger mechanism is configured to harvest energy from a movement of a portable device. The kinetic energy scavenger mechanism includes at least one piezo member. The frequency tuning system is connected to the kinetic energy scavenger system. The frequency tuning system is configured to tune a harvesting frequency of the at least one piezo member based on, at least partially, a characterization of the movement of the portable device.

According to another example of the invention, an apparatus is disclosed. The apparatus includes a housing, electronic circuitry, and an energy harvesting system. The electronic circuitry is in the housing. The energy harvesting system is proximate the housing. The energy harvesting system includes a kinetic member and a frequency tuning system. The frequency tuning system is configured to change a stiffness of the kinetic member based on, at least partially, a movement of the housing.

According to another example of the invention, a method is disclosed. A housing is provided. Electronic circuitry is installed in the housing. An energy harvesting system is provided proximate the housing. The energy harvesting system includes at least one piezo member and a frequency tuning system. The frequency tuning system is configured to tune a harvesting frequency of the at least one piezo member based on an operation mode of a portable device.

According to another example of the invention, a method is disclosed. Movements of a portable device are detected. The detected movements are analyzed. An environment of the portable device is determined based on, at least partially, the analyzed detected movements.

According to another example of the invention, a method is disclosed. Movements of a portable device are sensed. The sensed movements are characterized. A stiffness of a kinetic energy harvesting member is changed based on, at least partially, the characterization of the sensed movements.

According to another example of the invention, a program storage device readable by a machine, tangibly embodying a program of instructions executable by the machine for performing operations to tune a frequency of an energy harvesting system is disclosed. A movement pattern of a portable device is detected. A frequency corresponding to the detected movement pattern is determined. A voltage is applied to a piezo member based on, at least partially, the determined frequency.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. An apparatus comprising:
a kinetic energy scavenger mechanism configured to harvest energy from a movement of a portable device, wherein the kinetic energy scavenger mechanism comprises at least one piezo member; and
a frequency tuning system connected to the kinetic energy scavenger system, wherein the frequency tuning system is configured to tune a harvesting frequency of the at least one piezo member based on, at least partially, a characterization of the movement of the portable device.

2. An apparatus as in claim 1 further comprising a battery charger connected to the kinetic energy scavenger mechanism, and wherein the frequency tuning system further comprises an offset optimizer.

3. An apparatus as in claim 2 wherein the offset optimizer is connected between the battery charger and the kinetic energy scavenger mechanism.

4. An apparatus as in claim 3 wherein the offset optimizer is configured to apply a DC offset to the kinetic energy scavenger mechanism.

5. An apparatus as in claim 1 wherein the at least one piezo member is a piezo cantilever member.

6. A device comprising:
a housing;
electronic circuitry in the housing; and
an apparatus as in claim 1, wherein the apparatus is connected to the housing.

7. An apparatus comprising:
a housing;
electronic circuitry in the housing; and
an energy harvesting system proximate the housing, wherein the energy harvesting system comprises a kinetic member and a frequency tuning system, and wherein the frequency tuning system is configured to change a stiffness of the kinetic member based on, at least partially, a predicted movement pattern of the housing.

8. An apparatus as in claim 7 further comprising at least one sensor connected to the energy harvesting system.

9. An apparatus as in claim 7 further comprising at least one acceleration sensor connected to the frequency tuning system.

10. An apparatus as in claim 7 wherein the energy harvesting system further comprises a battery charger, and wherein the frequency tuning system further comprises an offset optimizer, wherein the offset optimizer is connected between the battery charger and the kinetic member.

11. An apparatus as in claim 7 wherein the frequency tuning system is configured to apply a DC offset to the kinetic member.

12. An apparatus as in claim 7 wherein the kinetic member is a kinetic cantilever member.

13. An apparatus as in claim 7 wherein the kinetic member is configured to have an adjustable length.

14. An apparatus as in claim 7 wherein the kinetic member is a kinetic piezo member.

15. An apparatus as in claim 7 wherein the frequency tuning system is configured to receive an input from a separate portable device.

16. An apparatus as in claim 15 wherein the frequency tuning system is configured to receive the input from a sensor and/or an application of the separate portable device.

17. An apparatus as in claim 15 wherein the apparatus is a headset, and wherein the separate portable device is a mobile phone.

18. A method comprising:
providing a housing;
installing electronic circuitry in the housing; and
providing an energy harvesting system proximate the housing, wherein the energy harvesting system comprises at least one piezo member and a frequency tuning system, and wherein the frequency tuning system is configured to tune a harvesting frequency of the at least one piezo member based on an operation mode of a portable device.

19. A method as in claim 18 wherein the energy harvesting system further comprises a battery charger, wherein the providing of the energy harvesting system further comprises connecting an offset optimizer between the battery charger and the at least one piezo member.

20. A method as in claim 18 further comprising connecting the energy harvesting system to a sensor in the housing.

21. A method as in claim 18 wherein the providing of the energy harvesting system comprising at least one piezo member further comprises providing an energy harvesting system comprising at least one kinetic cantilever piezo member.

22. A method comprising:
detecting movements of a portable device;
analyzing the detected movements; and
determining an environment of the portable device based on, at least partially, the analyzed detected movements.

23. A method as in claim 22 wherein the detecting movements of the portable device further comprises detecting vibrations of the portable device.

24. A method as in claim 22 further comprising:
applying a DC voltage to a kinetic piezo member of the portable device in response to the determined environment.

25. A method comprising:
sensing movements of a portable device;
characterizing the sensed movements; and
changing a stiffness of a kinetic energy harvesting member based on, at least partially, the characterization of the sensed movements.

26. A method as in claim 25 wherein the changing of the stiffness of the kinetic energy harvesting member further comprises changing a resonant frequency of the kinetic energy harvesting member.

27. A method as in claim 25 wherein the changing of the stiffness of the kinetic energy harvesting member further comprises applying a voltage to the kinetic energy harvesting member.

28. A method as in claim 25 wherein the changing of the stiffness of the kinetic energy harvesting member further comprises changing a stiffness of a piezo member.

29. A method as in claim 25 wherein the sensing of the movements of the portable device further comprises utilizing an existing sensor of the portable device.

30. A method as in claim 25 wherein the kinetic energy harvesting member is disposed within another different portable device.

31. A program storage device readable by a machine, tangibly embodying a program of instructions executable by the machine for performing operations to tune a frequency of an energy harvesting system, the operations comprising:
detecting a movement pattern of a portable device;
determining a frequency corresponding to the detected movement pattern; and
applying a voltage to a piezo member based on, at least partially, the determined frequency.

32. A program storage device as in claim 31 wherein the applying of the voltage to the piezo member further comprises applying a DC voltage to the piezo member, and wherein a frequency of the piezo member is tuned in response to the applying of the DC voltage.

33. A program storage device as in claim 31 wherein the applying of the voltage to the piezo member further comprises applying a DC voltage to the piezo member, and wherein a stiffness of the piezo member is adjusted in response to the applying of the voltage.

34. A program storage device as in claim 31 wherein the detecting of the movement pattern further comprises determining an operation mode of a device.

35. A program storage device as in claim 31 wherein the applying of the voltage further comprises applying a voltage to a piezo member of another different portable device.
